(19) United States
(12) Patent Application Publication
(10) Pub. No.: US 2023/0322569 A1
(43) Pub. Date: Oct. 12, 2023

(54) PROCESS AND APPARATUS FOR PRODUCING ALKALI BICARBONATES AND ALKALI CARBONATES

(71) Applicant: AIROVATION TECHNOLOGIES LTD., Ness Ziona (IL)

(72) Inventors: Marat MAAYAN, Ramat-Gan (IL); Uri STOIN, Jerusalem (IL); Itzhak TAFF, Yavne (IL)

(21) Appl. No.: 18/335,092

(22) Filed: Jun. 14, 2023

Related U.S. Application Data
(63) Continuation-in-part of application No. PCT/IL2021/051488, filed on Dec. 14, 2021.
(60) Provisional application No. 63/125,553, filed on Dec. 15, 2020.
(60) Provisional application No. 63/354,393, filed on Jun. 22, 2022.

(51) Int. Cl. C01D 7/07; B01D 53/62; C01B 32/60; B01D 53/78

(52) U.S. Cl. CPC C01D 7/07; B01D 53/62; C01B 32/60; B01D 53/78; B01D 2258/0283; B01D 2251/304; B01D 2251/604; B01D 2257/504; B01D 2251/106

(57) ABSTRACT

The invention relates to a process for preparing alkali carbonate/bicarbonate salts, comprising continuously feeding aqueous alkali hydroxide solution into a gas-liquid contactor; forcing incoming CO₂-containing gas stream through a sparging device submerged in the gas-liquid contactor below the surface level of the aqueous alkali hydroxide solution, to generate bubbles and/or microbubbles; adding hydrogen peroxide in proximity to orifices of the sparging device, from which the bubbles and/or microbubbles evolve, wherein the supply of hydrogen peroxide is adjusted to decrease alkali carbonate formation and increase alkali bicarbonate formation; and continuously discharging an effluent from the gas-liquid contactor and recovering therefrom carbonate and bicarbonate alkali salts predominated by the bicarbonate component. A gas liquid-contactor and an apparatus are also provided by the invention.

Alkali bicarbonates and carbonates can be prepared by passing carbon dioxide through an aqueous solution of alkali hydroxide. A useful source of carbon dioxide is found in industrial CO₂-bearing gas streams. For example, carbon dioxide emitted by fossil-fired power plants, or present in other industrial gas streams, can be captured by scrubbing the gas with an aqueous solution of alkali hydroxide. This could serve a twofold purpose: reduction of CO₂ emission to the atmosphere and its direct, on-site conversion to commercially useful chemical reagents. For example, sodium bicarbonate (NaHCO₃) is used in baking powders (it is also known as “baking soda”) and in the textile, paper and ceramics industries.

Various scrubber designs have been proposed to achieve the goal of CO₂ capture from flue gases by alkali hydroxide solution, and the recovery of the carbonate/bicarbonate products. The conventional approach is based on a countercurrent packed column, i.e., an alkaline solution is sprayed from the top of a column filled with a packing material to become mixed with an incoming CO₂-bearing gas flowing upward, as shown by Salmon et al. [Applied Science 2018, 8, 996], where the performance of a packed column was compared to that achieved by a fibrous membrane contactor. Other designs can be found in WO 2011/129707 and in U.S. Pat. No. 7,727,374; the latter specifically mentions CO₂/NaOH bubble column designs. Shim et al. [Environmental Engineering Research, 2016; 21(3):297-303] reported that production of sodium bicarbonate in a bubble reactor had met with difficulties because the micro-sized holes of the sparger used to produce the bubbles were clogged by crystals of sodium carbonate, which precipitated out of the solution.

In co-assigned WO 2018/002710, it was proposed to remove target gases from air, mainly carbon monoxide arising in case of fire, with the aid of aqueous alkali hydroxide/hydrogen peroxide (MOH/H₂O₂ reagent; M=alkali metal, e.g., Na or K), using gas/liquid contact pattern based on creation of bubbles or microbubbles. The rationale behind this approach is that decomposition of hydrogen peroxide in a strongly alkaline solution, when controlled to adhere to certain stoichiometry, i.e., 2:3 molar ratio (MOH:H₂O₂) at appropriate pH, could result in very strong oxidation properties, owing to formation of the superoxide radical anion (O₂—⋅). The generation of the superoxide was previously reported in a series of publications (WO 2013/093903; Stoin et al. ChemPhysChem, 2013, 14, 4158; and WO 2015/170317), where it was shown that the aqueous MOH/H₂O₂ reagent is useful in treating different pollutants, such as absorption of carbon dioxide from flue gases.

We have now studied the production of sodium carbonates/bicarbonates through the capture of CO₂ by an alkaline solution, where the gas is brought into contact with the solution in the form of microbubbles. One factor which needs to be taken into consideration is the different solubility in water of the two salts: sodium carbonate is considerably less soluble in water than sodium bicarbonate (the same is true for the corresponding potassium salts). Because of this difference in solubility, predominance of sodium carbonate in the product may impair the efficiency of the process, due to clogging of the holes in the sparger generating the microbubbles, following premature crystallization of sodium carbonate. A similar problem was reported by Shim et al (supra) in their experimental set-up; the authors recommended to switch to a different design, incorporating a packed column.

Experimental work conducted in support of this invention indicates that controlled addition of hydrogen peroxide to an alkaline solution operating to capture CO₂ in a microbubbles/liquid contact pattern, improves the conversion of CO₂ into the salt products. In the presence of a suitable amount of added H₂O₂, high conversion rates of CO₂ were measured over long time periods, suppressing the crystallization of sodium carbonate, presumably by shifting the chemistry in favor the formation of sodium bicarbonate.

As shown by the experimental results reported below, in the absence of hydrogen peroxide, acceptable CO₂ conversion rates (e.g., 80-90%) by the alkaline solution are developed quite slowly and are difficult to maintain over time. On the other hand, addition of a high amount of H₂O₂, to promote the stoichiometry recommended in WO 2013/093903, i.e., the 2:3 molar ratio (MOH:H₂O₂) r was shown to achieve high CO₂ conversion very rapidly, but the chemical absorption of CO₂ by the alkaline solution could not have been maintained over long time period. CO₂ capture by the alkaline solution ceased abruptly, apparently due to sodium carbonate exceeding its solubility limit in the solution, leading to crystallization and clogging of the pores in the membrane which served to generate the microbubbles. That is, a 2:3 molar ratio (MOH:H₂O₂) advances the formation of Na₂CO₃—the less favorable product when a contact pattern based on microbubbles/liquid is used, as suggested by the chemical reaction represented by equation (1):

2NaOH+3H₂O₂+CO₂→Na₂CO₃+4H₂O+1.5O₂ (1)

However, we have found that moderate supply of H₂O₂ to the alkaline solution, in close proximity to the orifices of the sparging device creating the bubbles, led to very good CO₂ conversion rates which lasted over long test periods, with preferential formation of the bicarbonate salt. Without wishing to be bound by theory, it is believed that under slow addition of H₂O₂ to the alkaline solution, there is a sub-stoichiometric amount of H₂O₂ available to participate in the conversion of CO₂ [by “sub-stoichiometric amount” is meant less than the 2:3 molar ratio (MOH:H₂O₂) of equation (1)]. Under these condition, the reaction which preferentially takes place in the vicinity of the orifices of the sparging device is a bicarbonate formation reaction, e.g.:

NaOH+nH₂O₂+CO₂→NaHCO₃+nH₂O+½nO₂(0.1≤n≤0.4) (2)

rather than the carbonate formation reaction, thereby minimizing, or delaying, blockage of the orifices of the sparging device by carbonate crystals.

Accordingly, the invention is primarily directed to a process for preparing alkali carbonate and/or bicarbonate salts, comprising:
continuously feeding alkali hydroxide into a gas-liquid contactor;
forcing incoming CO₂-containing gas stream through a sparging device submerged in the gas-liquid contactor below the surface level of the aqueous alkali hydroxide solution, to generate bubbles and/or microbubbles;
adding hydrogen peroxide in proximity to orifices of the sparging device, from which the bubbles/microbubbles evolve, wherein the supply of hydrogen peroxide is adjusted to decrease alkali carbonate formation and increase alkali bicarbonate formation; and
continuously discharging an effluent from the gas-liquid contactor and recovering therefrom carbonate/bicarbonate alkali salts predominated by the bicarbonate component. CO₂-containing gases drawn from industrial facilities, e.g., flue gases emitted by fossil-fired power plants, can serve as a source of carbon dioxide in the production of the carbonates/bicarbonates. CO₂ level in the incoming gas stream is not less than 380 ppm, e.g., vary in the range from 10,000 to 200,000 ppm (from 1 to 20%, e.g., from 1 to 18%, e.g., from 1 to 15%, e.g., from 7 to 14% CO₂). For example, the flue gas can first pass through a series of treatments, consisting of particulate removal (e.g., by filtration or electrostatic precipitation), denitrification unit (conversion of nitrogen oxides) and wet scrubbing (for selective removal of SO₂), to generate CO₂-containing gas which is essentially free of other acidic components (the gas temperature at this stage is generally from 100-200° C.). It is also possible to use particulate-free flue gas, in which case, however, SO₂ content of the gas should be less than 10000 ppm, to minimize competition with carbon dioxide.

The chemical absorption of CO₂ by the alkaline solution to produce the bicarbonate/carbonate salts takes place in a reactor designed as a gas-liquid contactor (hereinafter the terms “reactor” and “gas-liquid contactor” are used interchangeably). Before it enters the gal-liquid contactor, the NOₓ and SOₓ-free flue gas is passed through a heat exchanger (to cool the gas stream to about 40-50° C.). The heat released by the flue gas can be recovered using a stream of fresh air, which may be guided to serve downstream operations, i.e., the separation of the bicarbonate/carbonate salts from the reaction mixture as described below. Water vapors present in the flue gas undergo condensation; water droplets can be removed from the two-phase fluid flow in a gas-liquid separator, e.g., horizontal or vertical knockout drum. The gas stream is now directed to the gas-liquid contactor, where the salts formation reactions occurs.

Regarding the aqueous MOH solution (e.g., NaOH or KOH), the concentration of the solution fed to the gas/liquid contactor is >10% by weight and up to saturation (48%), e.g. in the range of 25 to 35%, usually ˜30% by weight. The aqueous solution can be prepared on-site, either by dilution of commercial saturated solutions with water, or by dissolution of solid alkali hydroxide (available in the marketplace in the form of granules, pellets or flakes) in water. To enable continuous feed of the MOH solution to the reactor, one (or more) MOH production units may be provided. Each MOH production unit consists of a mixing tank in which solid MOH and water (i.e., fresh water and water recovered from downstream operations) are mixed and a pump to deliver the MOH solution to the gas-liquid contactor. Suitable pumps are made of stainless steel, and operate, for example, at capacity in the range of 10 to 120 m³/hour, or any other range, to meet the demand of the plant emitting the CO₂ gas. Such a set-up, consisting of alternately operating MOH production and supply units, enables one unit to be active in supplying a pre-prepared MOH solution as a feed stream to the gas-liquid contactor (MOH charge phase), and the other to produce and store MOH solution (MOH production phase), with the bicarbonate/carbonate preparation process of the invention switching from one unit to another. Because the dissolution reaction of MOH in water is exothermic, it is beneficial to have each MOH production unit equipped with a recirculation line, such that MOH solution withdrawn from the mixing tank is passed through a cooler, whereby heat generated during the dissolution reaction is released from the MOH solution and absorbed by a chilled water stream, with the cooled MOH stream returning to the mixing tank.

Regarding the hydrogen peroxide, it is supplied to the reactor in an aqueous form, at a concentration of—for example—from 4 to 50%, e.g., 10 to 50%, e.g., 30 to 40% by weight, e.g., by using a commercial 35% by weight grade, or by diluting H₂O₂ grades of higher strengths (50-70% by weight).

Turning now to the design of the gas-liquid contactor, it should be noted that the sparging device mounted in the gas-liquid contactor, to convert the incoming CO₂-containing streams into microbubbles, may be configured in different geometries, e.g., flat geometry (perforated plates, horizontally positioned membranes) and tubular configuration.

However, one preferred process design is based on forcing incoming CO₂-containing gas stream through an array of tunnel-shaped sparging units submerged in the gas-liquid contactor below the surface level of the aqueous alkali hydroxide solution, wherein a sparging unit is bounded, at least in part, by a curved surface. For example, a sparging unit operative in the process of the invention may be in the shape of a semi-cylinder. The orifices of the sparging unit are distributed on its curved surface, as explained below. An important property of the sparging device is that the size of orifices, through which the air/CO₂ gas mixture is forced to create the microbubbles, is less than 700 μm, e.g., less than 500 μm, e.g., diameter ranging from 50 to 300 μm, e.g., 100 to 200 μm. H₂O₂ addition to the gas-liquid contactor preferably takes place by injecting a plurality of individual H₂O₂ streams in proximity to the orifices provided on the curved surface of the tunnel-shaped sparging units. This can be achieved with the aid of pipes positioned adjacent to, and parallel with, the sparging units, as described below.

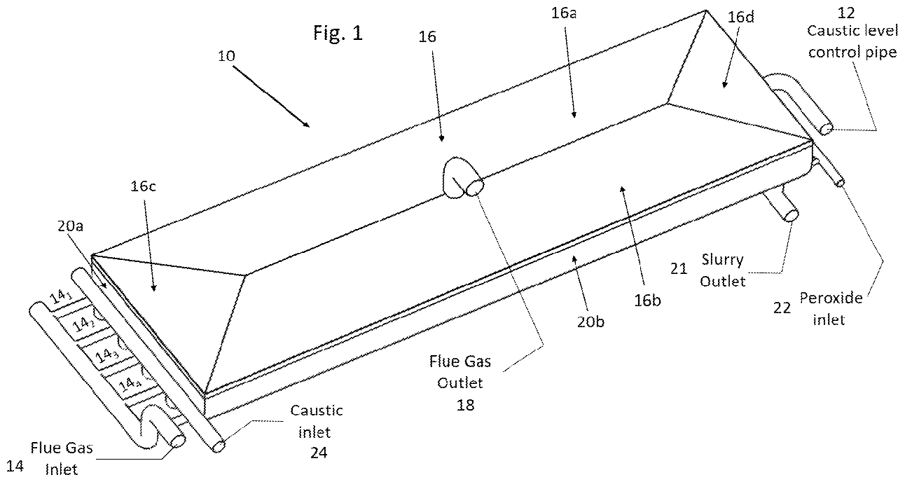

An illustrative gas-liquid contactor, with the characteristics set forth above, suitable for use in the preparation of bicarbonate/carbonate salts by the process of the invention, is described in detail in reference to FIGS. 1 to 5.

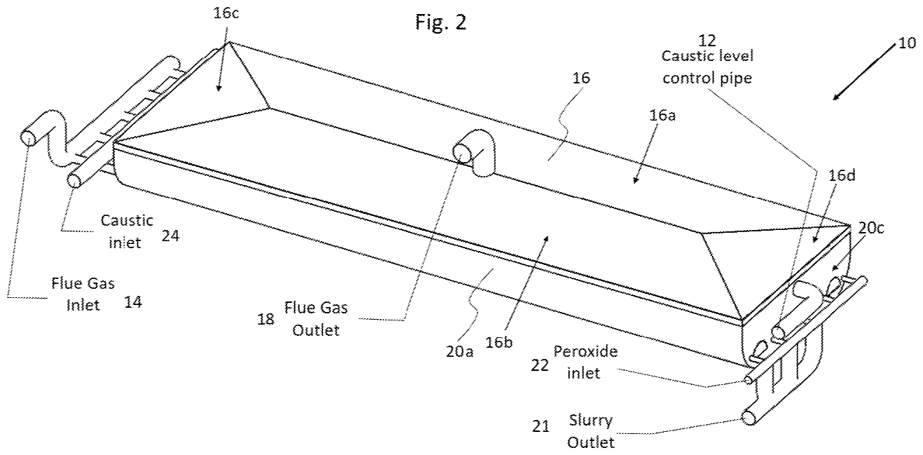

FIGS. 1 and 2 show a horizontal gas-liquid contactor (10) which is generally parallelepiped in shape, bounded by a bottom surface, a top section (16) and four lateral faces (20a, 20b, 20c and (20d; not shown)). To be able to effectively absorb CO₂ from flue gases emitted by typical power plant, the length, width and height of the gas-liquid contactor (10) are adjusted in the ranges of 100 to 600 cm, 100 to 250 cm and 30 to 100 cm, respectively.

A blower/fun (not shown), e.g., operating to generate gas flow of 1000-7000 m³/hour, draws the air/CO₂ stream into the reactor. A gas manifold (14, 14₁, 14₂, . . . 14ₙ; e.g., 1≤n≤8) is installed in a lateral face (20a) of the gas-liquid contactor (10), dividing the incoming gas stream flowing via conduit of 30-100 cm in diameter (14) into subsidiary streams which enter reactor (10) via pipes (14₁, 14₂, . . . 14ₙ). A purified (CO₂-free) air stream is released through gas outlet opening (18), which is centrally positioned in the top section (16) of the reactor (the design illustrated for top section (16), consisting of inclined trapezoidal plates 16a and 16b and inclined triangular plates (16c, 16d), creating a sloping roof design, is not mandatory)).

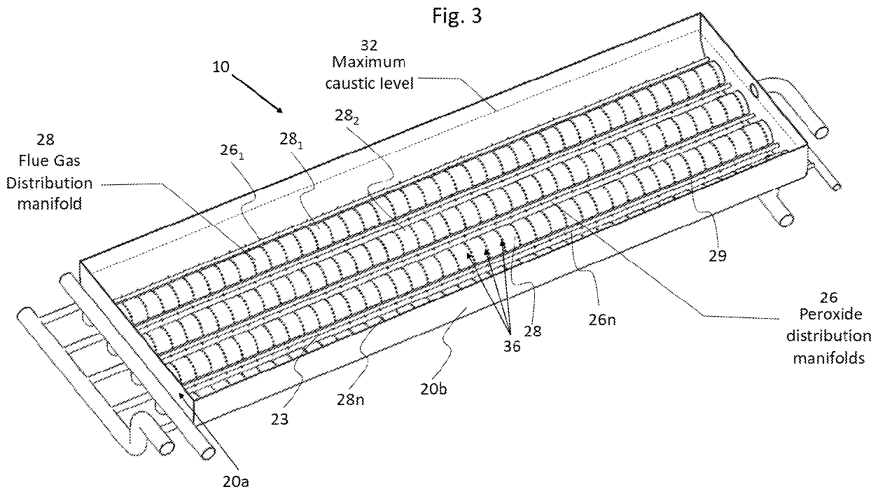

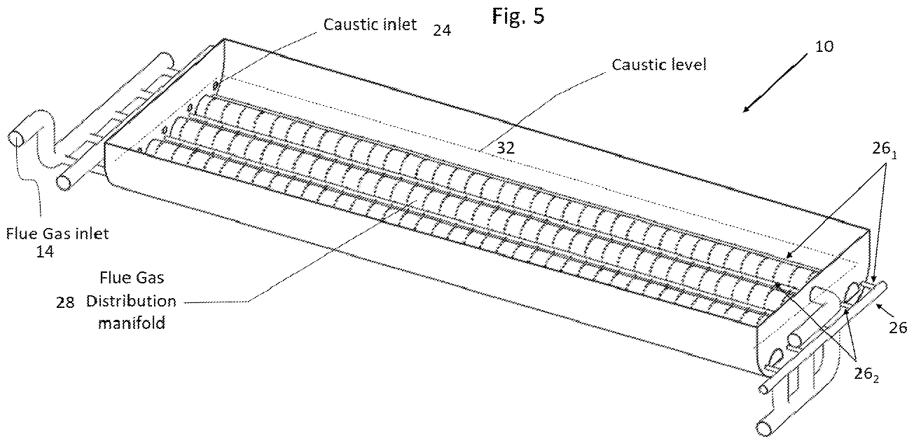

The aqueous alkali hydroxide solution is fed to the gas-liquid contactor (10) by pipe (24) through one of the lateral sides of the gas-liquid contactor (e.g., the same side (20a) of the reactor, through which the incoming air/CO₂ gas stream enters). Pipe (24) is installed in parallel to lateral side (20a) such that the aqueous alkali hydroxide solution flows into the reactor via evenly spaced openings shown in the corresponding internal wall in FIG. 5. The level of the alkaline solution in the reactor is marked by a dashed line (32) along the internals walls of the reactor in FIGS. 3 and 5. Excess of the alkali hydroxide solution above the maximal level is removed from the reactor via control pipe 12. The level of the alkali hydroxide solution 32 is designed to ensure sufficient scrubbing of the gas (in the form of microbubbles) with the aqueous alkali hydroxide solution, thereby removing carbon dioxide from the flue gas to produce the salts.

The aqueous hydrogen peroxide is fed to the reactor (10) from the opposite lateral side (20c), with the aid of a manifold (26) splitting the main H₂O₂ feed solution into a plurality of individual stream which enter the reactor and flow across an array of pipes disposed in the gas-liquid contactor (shown in FIGS. 3 to 5).

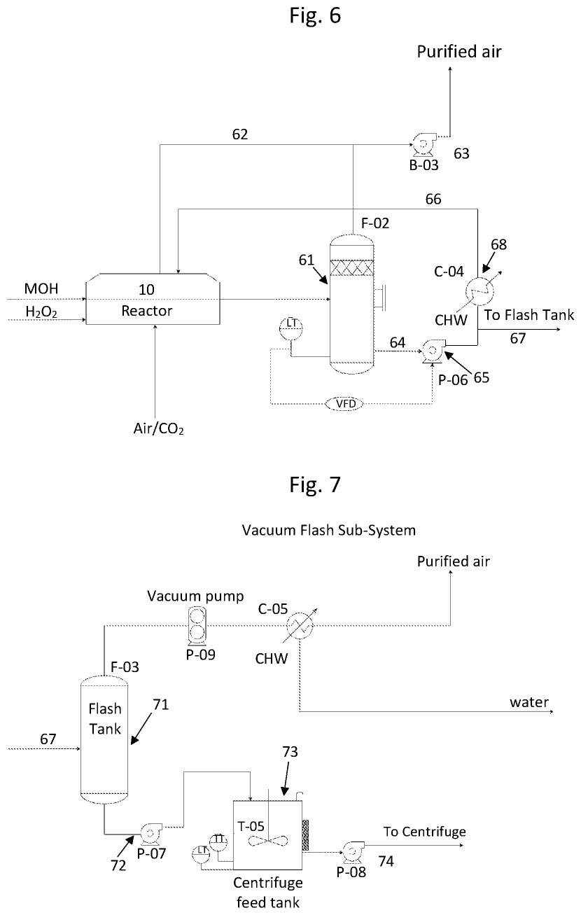

Numeral (21) indicates a discharge pipe, through which the reaction mixture is continuously discharged (and treated to recover the crystalline bicarbonate/carbonate salts, as shown in FIGS. 6 to 8).

The interior of the gas/liquid contactor, with the unique arrays of sparging units and H₂O₂ pipes installed therein, is now described in detail in reference to FIGS. 3 to 5.

Tunnel-shaped sparging units (28₁), (28₂), . . . , (28ₙ) are placed horizontally and parallel to each other at the bottom of gas/liquid contactor (10), below the surface level of the alkaline solution (marked by a dashed line (32). The distance between adjacent sparging units is from 5 to 50 mm, e.g., 10 30 mm. For example, the cross-section of a tunnel-shaped sparging unit corresponds to a circle or a segment of a circle with radius in the range from 10 mm to 300 mm i.e., a part of a circle bounded by an arc and its chord, wherein the corresponding central angle α that lies on the chord is preferably in the range from 90° a 360°. For Example, the tunnel-shaped sparging unit has the shape of a semi-cylinder (α=1800). In another example, the tunnel-shaped sparging unit has a tubular shape (full circle, α=360°).

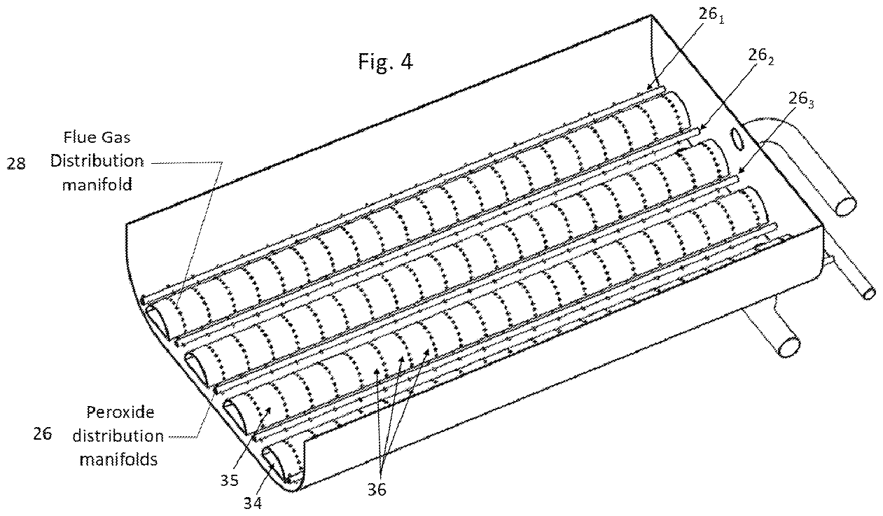

In the specific design shown in FIGS. 3 to 5, e.g., FIG. 4, a tunnel-shaped sparging unit is bounded by a longitudinally extending flat base (34) (e.g., rectangularly shaped base, which is attached to, or is part of, the floor of the gas/liquid contactor), wherein the opposite longitudinal sides of the base (34) are joined by a curved surface (35), defining an interior space into which a gas stream is directed from pipe (14ₙ) of manifold (14). In the specific design of FIG. 4, curved surface (35) defining a tunnel-shaped sparging unit is the lateral surface of a semi-cylinder.

Orifices (29) are distributed densely along the length of the curved surface of the tunnel-shaped sparging unit, preferably in a uniform manner, e.g., creating a pattern consisting of orifices arranged in transverse rows along the length of the curved surface, or more precisely, in arcs (36) (owing to the curvatures of the surface). Adjacent arcs are spaced 0.5 to 10 mm apart. Each arc consists of a plurality of orifices; the center-to-center distance between adjacent orifices is from 0.5 mm to 5 mm. As pointed out above, the diameter of the orifice is between 50 and 700 μm, to ensure the creation of microbubbles of a desired size within the aqueous solution.

The semi-cylindrical or cylindrical sparging units are optionally rotatable along their axial axis, to create shear forces acting on the bubbles evolving through the orifices, to reduce their size, and expel salt crystals from the vicinity of the orifices to the bulk solution.

Manifold (26) comprises a plurality of H₂O₂ tubes (26₁, 26₂, . . . , 26ₘ; m≥n). At least one peroxide tube (26ᵢ) is disposed in a space between two adjacent sparging units, that is, parallel to the sparging units. The H₂O₂ tubes and the sparging units are approximately equal in length, but the H₂O₂ tubes are smaller in diameter, e.g., H₂O₂ tube typically has a diameter of between 3 mm and 30 mm. Nozzles (23) are disposed along the length of the H₂O₂ tube, having a diameter between 0.1 mm and 2 mm, with the nozzle tips being directed towards one of the two adjacent sparging units. The nozzles are preferably evenly spaced along the H₂O₂ tube, the distance between adjacent nozzles being, for example, between 1 cm and 10 cm. To ensure sufficient flushing of the surface (35), each of the nozzles injects a pressurized stream at a small inclined angle of 1 deg to 90 deg relative to the horizontal. It has been found that a supply of continuous pressurized H₂O₂ streams directed towards each of the sparging units (28) minimizes the accumulation of sodium carbonate crystals, which over time clog the orifices (29) of the sparging units. The sparging units (28) and H₂O₂ tubes (26) are made of stainless steel.

Another aspect of the invention is a gas-liquid contactor, comprising:
a longitudinal horizontal housing bounded by a bottom surface, a top section and lateral faces;
an array of tunnel-shaped sparging units (28₁), (28₂), . . . , (28ₙ), placed horizontally and parallel to each other in the interior of the housing, wherein a sparging unit is bounded by an upward facing curved surface, with orifices distributed on said curved surface;
an array of tubes (26₁, 26₂, 26ₘ; m≥n), placed horizontally and parallel to each other in the interior of the housing, each tube is provided with nozzle tips arranged along its length, with at least one tube being disposed in a space between a pair of adjacent tunnel-shaped sparging units;
a gas inlet manifold coupled to said array of tunnel-shaped sparging units, suitable for introducing individual gas streams into said tunnel-shaped sparging units, installed, e.g., externally to a first lateral face of the gas-liquid contactor;
a gas outlet opening located in the top section, connected to a gas discharge line;
a first liquid feed line configured to provide a liquid flow (e.g., of aqueous alkali hydroxide) into said housing via one or more liquid inlet openings located, e.g., in at least one of the lateral faces of said housing (e.g., said first lateral face);
a second liquid feed line configured to provide liquid flow (e.g., of aqueous hydrogen peroxide) across said array of tubes, installed, e.g., in a second lateral side opposite to said first lateral side; and
a discharge opening, to which a discharge line is connected, to remove reaction product from the gas-liquid contactor.

On industrial scale, the flow rate of the alkali hydroxide solution fed continuously to the gas-liquid contactor is from 10 to 120 m³/hour. As pointed out above, the flow rate of the H₂O₂ supplied to the gas-liquid contactor is adjusted, e.g., within the range of 1 to 20 m³/hour such that carbonate formation is minimized and bicarbonate formation is maximized, e.g., the molar concentration of the bicarbonate in the product recovered is not less than 70%, e.g. >90%, >95%, >99%.

The feed rate of aqueous H₂O₂ may be determined by trial and error, based on the load of CO₂ in the incoming gas stream, the concentration and purity of the alkali hydroxide solution and the specific design of the sparging units and H₂O₂ tubes, reaction and outside temperature, to achieve a steady flow of a pumpable slurry discharged from the gas-liquid contactor, with CO₂ conversion rates, on industrial scale, >80%-90%. Experimental work conducted in support of this invention in the lab suggests that an appropriate feed rate of aqueous H₂O₂ to achieve prolonged salt formation reaction is one that reaches high CO₂ conversion neither too slowly nor too rapidly. The flow rate of aqueous H₂O₂ may also be increased or decreased in response to analysis of the distribution of bicarbonate/carbonate salts in the product mixture.

The effluent which is continuously discharged from the reactor is an aqueous solution or more likely, a pumpable slurry. Isolation of the salts from the effluent consists of three major steps:
1) feeding the effluent to a gas-liquid separator to separate gas dissolved therein, withdrawing a solution/slurry from the bottom of the gas-liquid separator, recirculating a first portion of the solution/slurry, after it has been cooled, to the gas-liquid contactor;
2) concentrating a second portion of the solution/slurry, e.g., by partial evaporation; and
3) separating the solid salts from the aqueous phase and drying.

FIG. 6 illustrates the first step. Effluent stream from the reactor (10) flows to a first gas-liquid separator (61), where the gas dissolved in the effluent is removed to join the main purified (CO₂-free) gas stream (62), which is being released from the reactor (10) by the action of blower (63 B-03). The solution/slurry stream (64) which exits from the bottom of first gas-liquid separator is pumped (65 P06, e.g., capacity 75 m³/h; head 20 m water) and divided into two streams, one that is recirculated via recycle line (66) and returned to the reactor (10), and another stream (67) which proceeds to the next separation steps needed to recover the salts. Recycle line (66) is provided with a cooler (68 C-04), e.g., in the form of spiral heat exchanger, to facilitate heat removal from reactor (10). The salt formation reaction taking place in reactor (10) is exothermic; heat released by this reaction is recovered from the effluent of reactor (10) in cooler (68), thereby keeping a stable temperature in reactor (10).

FIG. 7 illustrates the second step, i.e., concentration of the solution/slurry. Stream (67) undergoes partial evaporation, e.g., in a flash drum (71 F-03), such that water vapors are removed under vacuum of 10 to 100 millibar (P-09), to force precipitation of solubilized salts. Water vapors undergo condensation (C-05, e.g., a flash condenser), to produce a water stream which can be supplied to the process, e.g., for the preparation of alkali hydroxide solution fed to a reactor (10). A pumpable slurry withdrawn from the bottom of flash drum (71) flows (pump 72 P-07) to an agitated tank (73 T-05), from which it is delivered by pump (74 P-08) to a solid/liquid separation unit.

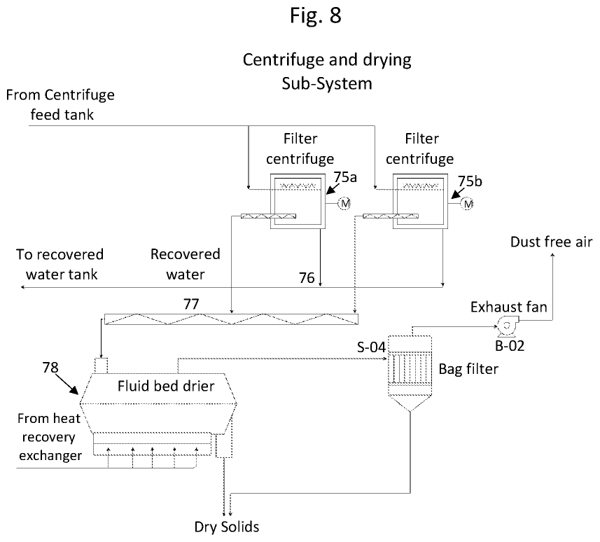

FIG. 8 illustrates the third step, i.e., isolation of the bicarbonate/carbonate salts. Separation of the solids from the stream delivered from tank (73) is achieved, for example, with the aid of continuous equipment for liquid/solid separation, such as one or more centrifuges, e.g., a continuous centrifuge or two or more switchable batch centrifuges (75a, 75b) operating alternately, such that a first batch centrifuge separates the liquid-solid mixture introduced thereinto, whereas the second batch centrifuge delivers the aqueous supernatant and wet cake produced: the aqueous supernatant (76) can be recycled and used in earlier steps of the process, e.g., to supply water to dissolve alkali hydroxide, as mentioned above. The wet salt particles are transferred, e.g., via conveyer screw (77) to a drier to remove residual moisture, e.g., by thermal drying. One suitable type of a drier is a fluidized-bed drier (78), because heat consumed by recovery from elsewhere in the process can be used, i.e., the air stream which absorbed heat from the incoming stream of flue gas at the very beginning of the process. The alkali carbonate/bicarbonate particles are preferably dried at a temperature not higher than 50° C. Other common types of driers can also be utilized. S-04 is bag filter, to further separate solids and release dust-free air using exhaust fan (B-02).

Another aspect of the invention is an apparatus for producing alkali bicarbonate/carbonate, to be placed at the vicinity of CO₂-emitting plant (e.g., a power plant, an incineration plant and SMR plant), comprising:
a gas-liquid contactor as described above;
a first blower forcing air/CO₂ stream through said gas-liquid contactor;
a set of pumps to deliver liquids and slurries;
upstream processing units, including:
   one or more tanks accommodating an aqueous alkali hydroxide solution, connected to the first liquid feed line of said gas-liquid contactor;
   one or more tanks accommodating hydrogen peroxide, connected to the second liquid feed line of said gas-liquid contactor,
   a first heat exchanger using ambient air driven by a second blower for heat transfer, said heat exchanger is provided with a feed line to receive air/CO₂ stream from a chimney stack of said plant, wherein the outlet of said heat exchanger is connected to a first gas-liquid separator, equipped with a gas discharge line and a liquid discharge line, to withdraw air/CO₂ and water streams, respectively, wherein said gas discharge line is connected to the gas inlet manifold of said gas-liquid contactor;
   downstream processing units, including:
a gas-liquid separator fed by an effluent discharge line of said gas-liquid contactor; wherein a gas discharge line of said gas-liquid separator optionally joins the gas discharge line of said gas-liquid contactor, and a liquid discharge line of said gas-liquid separator splits into two lines, a first line is a recycle line connected to said gas-liquid contactor, said recycle line being equipped with a second heat exchanger using chilled water for heat transfer, and a second line which is a feed line of an evaporation unit; wherein the gas discharge line of said evaporation unit is provided with a condenser, and the liquid discharge line of said evaporation unit is the feed line of a liquid-solid separation unit, equipped with a conveyer supplying separated solids to a dryer.

The process of the invention utilizes different CO₂-containing gases as a feedstock. For example, it may be used to convert CO₂ produced by steam methane reforming (SMR) into carbonate/bicarbonate salts. SMR generates hydrogen and CO₂ as by-product; so CO₂ capture/removal technologies are integrated into SMR. The invention is well suited for this purpose, i.e., to receive CO₂-containing gas from a steam methane reforming plant, to benefit from the relatively large concentration (˜17%) of CO₂ and absence of impurities in streams emitted by SMR. With such a feedstock, high purity grades of carbonates/bicarbonate salts can be obtained.

Another aspect of the invention is a multistep-step process that incorporates the MOH/H₂O₂ chemistry into the preparation of carbonate (e.g., Na₂CO₃) and alkali bicarbonate (e.g., NaHCO₃) in succession, i.e., producing Na₂CO₃ and NaHCO₃ in two separate reactors, designated in the description that follows Reactors A and B, respectively. The new process design offers high degree of flexibility as it can be manipulated to afford multiple valuable products, each of which is useful in its own right—Na₂CO₃, NaHCO₃ and CO₂—by exploiting their interconvertibility.

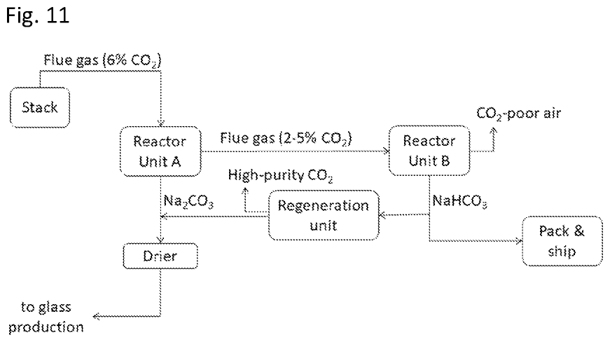

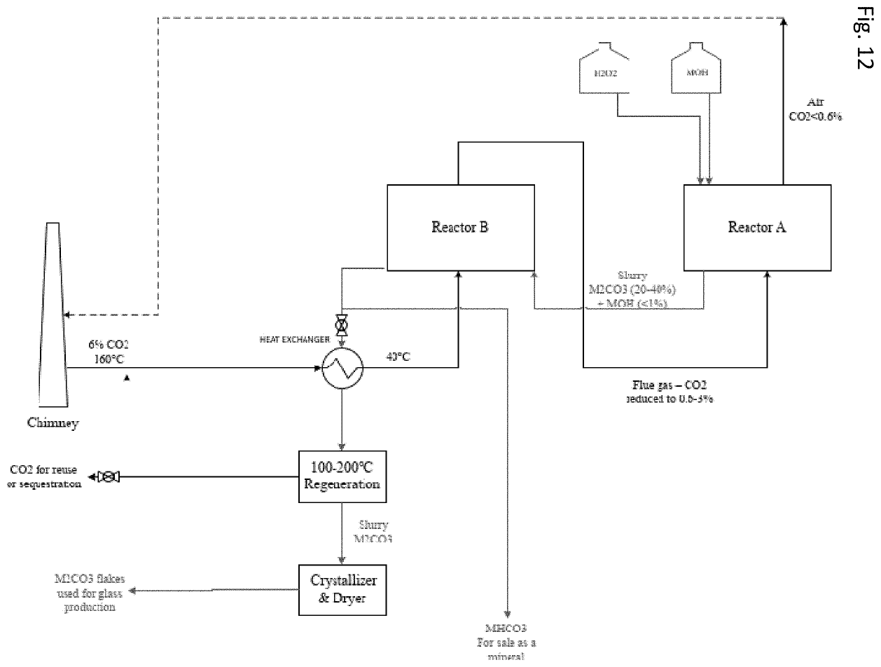

For example, the glass industry—a significant user of sodium carbonate—could benefit a lot from the proposed process design, as the gases emitted from the chimney stack of a glass-making plant could be treated to supply the Na₂CO₃ raw material consumed by the plant. That is, the invention enables the implementation of a “local” circular economy model in manufacturing sites of industries which use sodium carbonate in fuel-powered plants, such as the glass industry. Owing to the interconvertibility of the materials, each industry could decide on the desired proportions between the Na₂CO₃, NaHCO₃ and CO₂ products according to its needs, as shown in the flow charts of FIGS. 11 and 12.

Accordingly, the invention provides a process for preparing alkali carbonate and bicarbonate salts in sequence, comprising:
passing, in a first reactor, a CO₂-bearing gas stream through aqueous alkali hydroxide to form alkali carbonate and an outgoing gas stream with reduced CO₂ concentration;
discharging from the first reactor an alkali carbonate-containing aqueous solution/slurry and feeding said aqueous solution/slurry to a second reactor, optionally after some alkali carbonate has been recovered from the aqueous solution/slurry;
passing, in the second reactor, a CO₂-bearing gas stream through the alkali carbonate-containing aqueous solution/slurry, to form alkali bicarbonate and an outgoing gas stream with reduced CO₂ concentration;
recovering alkali bicarbonate in a solid form from a liquid effluent of the second reactor; or thermally decomposing the alkali bicarbonate into alkali carbonate, carbon dioxide and water, to recover alkali carbonate and/or carbon dioxide in industrially usable forms.

Each step involving CO₂ capture from a gas stream by an aqueous solution of NaOH and/or Na₂CO₃ can be achieved with the aid of hydrogen peroxide, as previously described. It should be noted that the CO₂-bearing gas supplied to the Na₂CO₃ formation reaction in Reactor A could be the high CO₂ content gas emitted from the chimney, with the outgoing gas stream from Reactor A, with reduced CO₂ content, moving on to Reactor B, as a feed in the NaHCO₃ formation reaction. But reversing the order of gas feed is possible as well, namely, the high CO₂ content gas emitted from the chimney is delivered to Reactor B, to be absorbed by alkali carbonate-containing aqueous solution/slurry and give the bicarbonate. In that case, the gas stream exiting Reactor B, with relatively low CO₂ level, is supplied to Reactor A, where it is absorbed in NaOH solution.

One useful flow chart of the process is seen in FIG. 11. CO₂ concentration in a flue gas released from the chimney stack of plants operating in the glass industry is, by way of example, from 4 to 12%, e.g., around 6%. Pretreatment includes cooling to about 30 to 50° C., removal of condensates and filtration; the gas stream is then blown to Reactor A. For example, Reactor A can have the same design as previously described in reference to FIGS. 1 to 5. Alternatively, Reactor A can be configured as a conventional gas-liquid contactor (e.g., a customary CO₂ scrubber), for instance, with a countercurrent flow design, mixing an upward flow of the gas with a downward flow of an aqueous sodium hydroxide solution at concentration of about 10 to 40% by weight. The aqueous NaOH solution is delivered to reactor A via a set of sprayers or other conventional arrangements mounted at the top section of Reactor A. CO₂ molecules in the gas stream are absorbed by the alkali solution, undergoing mineralization to form Na₂CO₃.

The outgoing gas stream which leaves Reactor A still carries significant amount of CO₂, for example, from 2 to 5%. So the excess flue gas that has not been treated in Reactor A is fed to reactor B, to complete the removal of CO₂ by transformation into bicarbonate, releasing CO₂-free air to the atmosphere.

The liquid effluent discharged by Reactor A can be divided into two portions. One portion is treated to recover sodium carbonate in a dry form, to meet the demand in the production plant. Na₂CO₃ is separated, by water evaporation in a drier. As shown in FIG. 11, the Na₂CO₃ can be supplied to the glass-making plant. The other portion of the liquid effluent, i.e., an aqueous stream consisting of unreacted NaOH, and/or dissolved/suspended Na₂CO₃, is the preferred feed for the next step which takes place in Reactor B (i.e., for the bicarbonate formation stage).

Reactor B is a gas-liquid contactor designed to advance conversion of the CO₂ molecules into sodium bicarbonate in a selective manner over sodium carbonate. For this reason, Reactor B can be configured as previously described, scrubbing CO₂ with fresh aqueous NaOH solution or even better, with the aqueous stream discharged from Reactor A, in the presence of hydrogen peroxide, leading to formation of sodium bicarbonate according to reaction equation (2) that was discussed in great detail above:

NaOH+nH₂O₂+CO₂→NaHCO₃+nH₂O+½nO₂(0.1≤n≤0.4) (2)

The effluent discharged from Reactor B is an aqueous solution or more likely, a pumpable slurry which contains sodium bicarbonate in a dissolved/suspended form. Having separated the sodium bicarbonate by the techniques discussed above in reference to FIGS. 6 to 8, the material is suitably packed to protect it against moisture pick-up, and delivered for shipping, or thermally decomposed on the production site of the glass industry as shown by reaction equation 3:

2NaHCO₃₍ₐ₎→Na₂CO₃₍ₛ₎+CO_{2(g)}+H₂O_{(g)} (3)

It is seen that the thermal decomposition of sodium bicarbonate produces pure CO₂ alongside sodium carbonate. So, following the bicarbonate generation step in Reactor B, the bicarbonate is passed through a thermal regeneration unit where it undergoes desorption at 100-200° C. to give back sodium carbonate and release high-purity CO₂. Na₂CO₃ that is obtained is transferred to a dryer positioned downstream to Reactor A, combined with the Na₂CO₃ directly produced in Reactor A, to be recycled and reused in the glass production plant. As to the CO₂, it may be compressed and utilized, for example by the food or refrigeration industries; returned to the gaseous feed of the process to minimize the amounts of unreacted sodium hydroxide; or disposed by injection into deep geological formations.

Another approach to benefit from the interconversion of Na₂CO₃, NaHCO₃ and CO₂ is seen in FIG. 12. In Reactor A, sodium carbonate formation reaction takes place, by capturing CO₂ molecules in sodium hydroxide solution in the presence of hydrogen peroxide. But this time, the CO₂-bearing gas supplied to Reactor A is not the ˜6% CO₂-rich gas emitted from the chimney. Rather, the ˜6% CO₂ flue gas emitted from the chimney is fed—after appropriate pretreatment—to Reactor B, supplying CO₂ molecules to convert the Na₂CO₃-containing effluent discharged from Reactor A, into NaHCO₃. The outgoing gas stream leaving reactor B, with reduced CO₂ level (say, 0.6-3.0%), flows to Reactor A. That is, the high content CO₂ gas is used in the NaHCO₃ formation step, whereas the low content CO₂ gas is fed to the Na₂CO₃ formation step.

As shown in detail FIG. 12, flue gas emitted from the chimney with typical CO₂ levels from 4 to 12% (e.g., around 6%, depending on the type of fuel used in the plant), is cooled from a temperature of −160° C. down to about 30-50° C., e.g., 40° C., by passage through a heat exchange. Liquids formed due to vapors that have condensed in the cooling stage are removed from the gas stream, which is directed to Reactor B, where the gas is forced to flow through the porous membrane/sparging units installed in the reactor (see the designs in FIGS. 1 to 5), and is bubbled through the liquid medium consisting of Na₂CO₃ and some unreacted NaOH and H₂O₂, that was supplied to Reactor B from Reactor A (an effluent discharged from Reactor A is a pumpable slurry with about 20-40 wt. % of Na₂CO₃ and <1.0 wt. % sodium hydroxide).

The outgoing gas stream is directed from Reactor B to Reactor A, carrying up to about 3% CO₂ (namely, more than half of the CO₂ loading was reduced as CO₂ molecules were absorbed by the carbonate in Reactor B to form the bicarbonate). Reactor A operates akin to the description pertaining to FIGS. 1 to 5, namely, it is supplied with NaOH and H₂O₂. The NaOH and H₂O are fed to Reactor A to advance carbonate formation reaction, which was already shown above by equation (1):

2NaOH+3H₂O₂+CO₂→Na₂CO₃+4H₂O+1.5O₂ (1)

So, in Reactor A, CO₂ molecules are absorbed in, and react with, the NaOH/H₂O₂ aqueous phase. The CO₂-depleted gas stream (up to about −0.3% CO₂ content) that leaves Reactor A could therefore be released to the atmosphere or recycled to the chimney, whereas the carbonate-containing liquid effluent discharged from Reactor A flows to Reactor B as previously described, to give the bicarbonate. The bicarbonate solution can be circulated through a heat exchanger at a temperature below 50° C. to minimize release of CO₂. The bicarbonate is useful in its own right, or it can be thermally decomposed as previously described in reference to FIG. 11 to give Na₂CO₃ slurry from which a solid material is collected in a usable form (e.g., Na₂CO₃ flakes), alongside CO₂ gas.

In the drawings:

FIGS. 1 and 2 show a perspective view of a gas-liquid contactor which is generally parallelepiped in shape, bounded by a bottom surface, a top section and four lateral faces.

FIGS. 3 to 5 show a perspective view of the interior of the gas-liquid contactor, with sparging units installed and an array of tubes deployed inside the gas-liquid contactor.

FIG. 6 schematically shows a gas-liquid separation unit downstream of the gas-liquid contactor.

FIG. 7 schematically shows a vacuum flash separation unit.

FIG. 8 schematically shows a centrifuge and a drying unit.

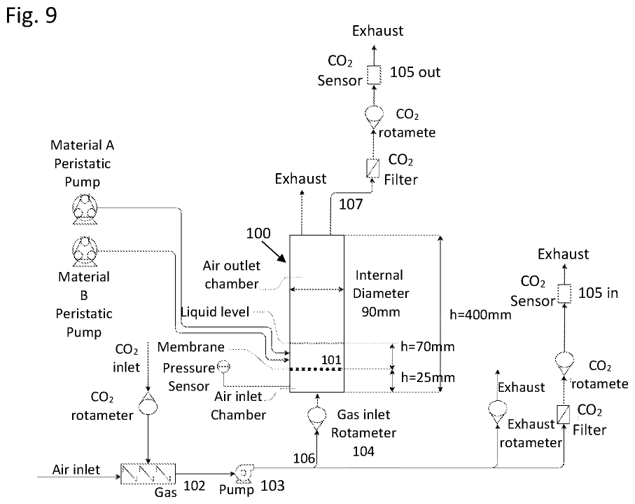

FIG. 9 shows the experimental set-up used in Examples 1 to 4.

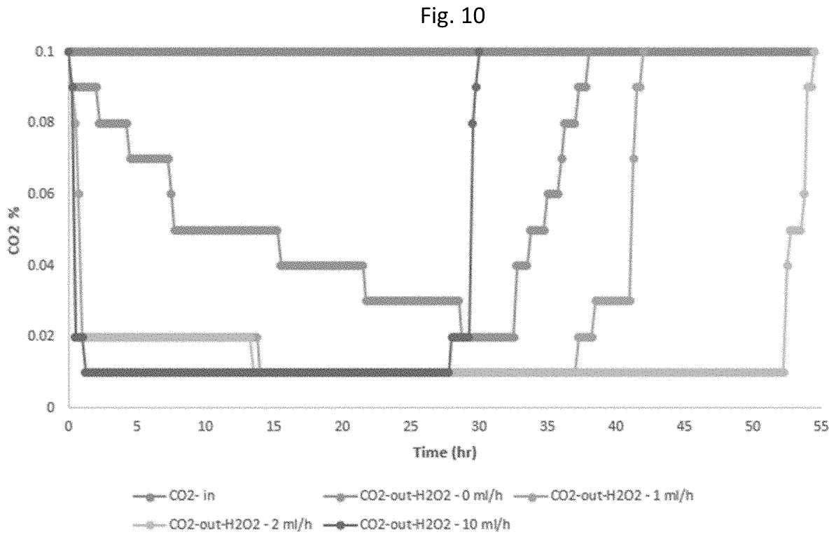

FIG. 10 is CO₂ levels versus time plot, measured in the experiments reported in Examples 1 to 4.

FIG. 11 is a flowchart of a process according to the invention.

FIG. 12 is a flowchart of a process according to the invention.

### EXAMPLES

### Examples 1 (Comparative) 2-3 (Invention) and 4 (Comparative)

A set of experiments was conducted to study the effect of addition of H₂O₂ on the chemical absorption of CO₂ from CO₂/air stream bubbled through sodium hydroxide solution.

The experimental set-up is shown in FIG. 9. Reactor (100) is tubular in shape (inner diameter: 9 cm; height: 40 cm). 5 mm thick stainless steel membrane (101) is mounted horizontally inside the reactor, about 2.5 cm from the bottom the reactor. The pore size of the membrane was 147 μm; center to center distance between adjacent pores is ˜50 μm.

In each of the experiments, the reactor was charged with 250 ml aqueous NaOH (30% by weight solution), such that the liquid level in the reactor was 7 cm, i.e., the membrane (101) was submerged about 4.5 cm below the surface level of the solution.

The CO₂ source was a commercial 100% CO₂ held in a gas cylinder. Pumps made CO₂ and air to flow into, and mix in, gas mixer (102) to create a mixed stream of 1000 ppm-CO₂ bearing air, which was directed by pump (103) to reactor (101) at a flow rate of 13 L/min (gas inlet rotameter (104)).

Hydrogen peroxide solution (10% solution) is continuously added to reactor (100) at different flow rates (1 ml/h, 2 ml/h and 10 ml/h; reference experiment with no addition at all) using peristaltic pump “B”. H₂O₂ stream is fed below the surface level of the sodium hydroxide solution in the reactor, in proximity to membrane (101).

A pair of CO₂ detectors (105in and 105out—BGA-EDG-MA, Emproco Ltd., Israel) connected to the incoming (1000 ppm-CO₂ bearing air and outgoing (purified) streams (106 and 107, respectively) were used to measure the concentration of CO₂, respectively.

During operation, the incoming air/CO₂ mixed gas stream (106) entered reactor (100) through the bottom of the reactor and was forced to flow through the membrane (101) to create bubbles. CO₂ was chemically absorbed by the sodium hydroxide medium. CO₂ levels in the incoming and outgoing gas streams were recorded continuously over the test period.

The results are presented graphically in FIG. 10. The constant CO₂ level in the incoming air/CO₂ gas stream measured throughout the time of the experiment is shown (1000 ppm=0.1%). CO₂ concentration plots versus time (measured in the outgoing stream) for each experiment are also shown. The end of the experiment is indicated by reaching equal CO₂ levels measured in the inlet and outlet streams (i.e., 1000 ppm).

It is seen that absent added H₂O₂, chemical absorption of CO₂ occurs, at least to some extent, over time period of 36 hours. However, during the test period, conversion rates measured were not satisfactory. With the supply of H₂O₂, conversion rates of CO₂ were improved significantly. Under addition of H₂O₂ at high flow rate (10 ml/h), a very efficient absorption (90%) is rapidly achieved, but cannot be maintained over long time periods (up to ˜27-28 hours). Moderate addition rates of H₂O₂ to the scrubbing system (at 1 ml/h and 2 ml/h) enable high conversion rates of CO₂ by the sodium hydroxide medium over prolonged time periods (˜40 hours and 53 hours, respectively). The conditions and results of the experiments also presented in tabular form below.

| | H2O2 flow rate | CO2 absorption | CO2 absorption |
|---|---|---|---|
| Example | (ml/hour) | lasted over | % |
| 1 (comparative) | 0 | 36 hours | 80% (measured |
| | | | over 5 hours) |
| 2 (invention) | 1 | 42 hours | 80-90% (measured |
| | | | over 37 hours) |
| 3 (invention) | 2 | 53 hours | 80%-90% (measured |
| | | | over 52 hours) |
| 4 (comparative) | 10 | 28 hours | 80-90% (measured |
| | | | over 26 hours) |

1. A process for preparing alkali carbonate/bicarbonate salts, comprising:
continuously feeding aqueous alkali hydroxide solution into a gas-liquid contactor;
forcing incoming CO₂-containing gas stream through a sparging device submerged in the gas-liquid contactor below the surface level of the aqueous alkali hydroxide solution, to generate bubbles and/or microbubbles;
adding hydrogen peroxide in proximity to orifices of the sparging device, from which the bubbles and/or microbubbles evolve, wherein the supply of hydrogen peroxide is adjusted to decrease alkali carbonate formation and increase alkali bicarbonate formation; and
continuously discharging an effluent from the gas-liquid contactor and recovering therefrom carbonate and bicarbonate alkali salts predominated by the bicarbonate component.

2. A process according to claim 1, wherein the incoming CO₂-containing gas stream flows through an array of tunnel-shaped sparging units submerged in the gas-liquid contactor below the surface level of the aqueous alkali hydroxide solution, wherein a sparging unit is bounded, at least in part, by a curved surface.

3. A process according to claim 2, wherein the orifices of the sparging unit are distributed on its curved surface and the diameter of the orifices is from 50 and 700 μm.

4. A process according to claim 3, wherein the addition of H₂O₂ to the gas-liquid contactor takes place by injecting a plurality of individual H₂O₂ streams in proximity to the orifices.

5. A process according to claim 1, wherein the concentration of the alkali hydroxide solution is from 10% by weight and up to saturation, the flow rate of the alkali hydroxide solution is from 10 to 120 m³/hour, the concentration of the hydrogen peroxide solution is from 4% to 50% by weight and the flow rate of the H₂O₂ solution is adjusted within the range of 1 to 20 m³/hour.

6. A process according to claim 5, wherein the molar concentration of the alkali bicarbonate in the product recovered is not less than 90%.

7. A process according to claim 1, wherein the flow rate of aqueous H₂O₂ is increased or decreased in response to analysis of the distribution of bicarbonate/carbonate salts in the product mixture.

8. A process according to claim 1, wherein the CO₂-containing gas stream is from a chimney of a power plant, incineration unit or steam methane reforming (SMR) plant.

9. A gas-liquid contactor, comprising:
a longitudinal horizontal housing bounded by a bottom surface, a top section and lateral faces;
an array of tunnel-shaped sparging units (28₁), (28₂), . . . , (28ₙ), placed horizontally and parallel to each other in the interior of the housing, wherein a sparging unit is bounded by an upward facing curved surface, with orifices distributed on said curved surface;
an array of tubes (26₁, 26₂, . . . , 26ₘ; m≥n), placed horizontally and parallel to each other in the interior of the housing, each tube is provided with nozzle tips arranged along its length, with at least one tube being disposed in a space between a pair of adjacent tunnel-shaped sparging units;
a gas inlet manifold coupled to said array of tunnel-shaped sparging units, suitable for introducing individual gas streams into said tunnel-shaped sparging units;
a gas outlet opening located in the top section, connected to a gas discharge line;
a first liquid feed line configured to provide a liquid flow of an aqueous alkali hydroxide into said housing via one or more liquid inlet openings;
a second liquid feed line configured to provide liquid flow of aqueous hydrogen peroxide across said array of tubes; and
a discharge opening, to which an effluent discharge line is connected, to remove reaction product from the gas-liquid contactor.

10. A gas-liquid contactor according to claim 9, wherein the gas inlet manifold is installed externally to a first lateral face of the gas-liquid contactor; the aqueous alkali hydroxide inlet openings are located in the first lateral side of said housing and the second liquid feed line is installed in a second lateral side, opposite to said first lateral side.

11. A gas-liquid contactor according to claim 10, wherein the second feed line comprises a manifold splitting the main H₂O₂ feed solution into a plurality of individual stream which enter the gas-liquid contactor and flow across the array of tubes disposed in the gas/liquid contactor.

12. A gas-liquid contactor according to claim 1, wherein the orifices are distributed densely along the length of the curved surface of the tunnel-shaped sparging unit, creating a pattern consisting of orifices arranged in transverse arcs, wherein adjacent arcs are spaced 0.5 to 10 mm apart, each arc consisting of a plurality of orifices, with the center-to-center distance between adjacent orifices being from 0.5 mm to 5 mm.

13. A gas-liquid contactor according to claim 9, wherein the diameter of the orifice is between 50 and 700 μm.

14. An apparatus for producing alkali bicarbonate/carbonate, to be placed at the vicinity of a CO₂-emitting plant such as a power plant, incineration plant and SMR plant, comprising:
a gas-liquid contactor as defined in claim 9;
a first blower forcing air/CO₂ stream through said gas-liquid contactor;
a set of pumps to deliver liquids and slurries;
upstream processing units, including:
one or more tanks accommodating an aqueous alkali hydroxide solution, connected to the first liquid feed line of said gas/liquid contactor;
one or more tanks accommodating hydrogen peroxide, connected to the second liquid feed line of said gas/liquid contactor,
a first heat exchanger using ambient air for heat transfer, said heat exchanger is provided with a feed line to receive air/CO₂ stream from a chimney of said plant, wherein the outlet of said heat exchanger is connected to a first gas-liquid separator, equipped with a gas discharge line and a liquid discharge line, to withdraw air/CO₂ and water streams, respectively, wherein said gas discharge line is connected to the gas inlet manifold of said gas-liquid contactor;
downstream processing units, including:
a gas-liquid separator fed by an effluent discharge line of said gas-liquid contactor; wherein a gas discharge line of said gas-liquid separator optionally joins the gas discharge line of said gas-liquid contactor, and a liquid discharge line of said gas-liquid separator splits into two lines, a first line is a recycle line connected to said gas-liquid contactor, said recycle line being equipped with a second heat exchanger using chilled water for heat transfer, and a second line which is a feed line of an evaporation unit; wherein the gas discharge line of said evaporation unit is provided with a condenser, and the liquid discharge line of said evaporation unit is the feed line of a liquid-solid separation unit, equipped with a conveyer supplying separated solids to a dryer.

15. A process for preparing alkali carbonate and bicarbonate salts in sequence, comprising:
passing, in a first reactor, a CO₂-bearing gas stream through aqueous alkali hydroxide to form alkali carbonate and an outgoing gas stream with reduced CO₂ concentration;
discharging from the first reactor an alkali carbonate-containing aqueous solution/slurry and feeding said aqueous solution/slurry to a second reactor, optionally after some alkali carbonate has been recovered from the aqueous solution/slurry;
passing, in the second reactor, a CO₂-bearing gas stream through the alkali carbonate-containing aqueous solution/slurry, to form alkali bicarbonate and an outgoing gas stream with reduced CO₂ concentration;
recovering alkali bicarbonate in a solid form from a liquid effluent of the second reactor; or thermally decomposing the alkali bicarbonate into alkali carbonate, carbon dioxide and water, to recover alkali carbonate and/or carbon dioxide in industrially usable forms.

16. A process according to claim 15, wherein the CO₂-bearing gas stream which enters the first reactor is a flue gas, and the CO₂-bearing gas stream which enters the second reactor is the outgoing gas stream with reduced CO₂ concentration that left the first reactor.

17. A process according to claim 15, wherein the CO₂-bearing gas stream which enters the second reactor is a flue gas, and the CO₂-bearing gas stream which enters the first reactor is the outgoing gas stream with reduced CO₂ concentration that left the second reactor.

18. A process according to claim 16, wherein the flue gas is emitted from a glass-producing industrial plant, to form sodium carbonate and sodium bicarbonate, with sodium carbonate being reused in the glass-producing industrial plant.

19. A process according to claim 1, wherein one or more steps of absorbing CO₂ molecules from CO₂-bearing gas stream into an alkaline solution is aided by addition of hydrogen peroxide to the alkaline solution.
